(19) United States
(12) Patent Application Publication
(10) Pub. No.: US 2014/0343974 A1
(43) Pub. Date: Nov. 20, 2014

(54) Selecting a Subset of Transit Trips Based on Time and Duration

(71) Applicant: Google Inc., (US)

(72) Inventors: Albert Graells, Zurich (CH); Lucien Pech, Zurich (CH)

(73) Assignee: Google Inc., Mountain View, CA (US)

(21) Appl. No.: 13/893,910

(22) Filed: May 14, 2013

(51) Int. Cl. G06Q 10/02

(52) U.S. Cl. CPC G06Q 10/02
USPC 705/5

(57) ABSTRACT

Systems and methods for filtering an initial set of transit trips between an origin and a destination to identify a subset of reasonable transit trips between the origin and the destination are provided. Once identified, the subset of reasonable transit trips can be further analyzed based on various criteria (e.g. earliest arrival, lowest price, least amount of waking, least number of transfers, etc.) to recommend one or more transit trips to a user. The subset of reasonable transit trips can be identified by obtaining transit trip data suitable for identifying a trip duration (e.g. departure time and arrival time) for each trip in the initial set of transit trips. This transit trip data can be used to filter out trips from the set that do not provide an optimal trip duration at some specific time over a time interval.

### FIELD

The present disclosure relates generally to public transportation trip planning and more particularly to identifying a subset of transit trips between an origin and a destination to be used in recommending transit trips to a user.

### BACKGROUND

Many services exist for planning a route using a transit system. Typically, a user inputs a departure and/or arrival time as well as origin and destination locations to the transit planning service. Search algorithms are used to identify possible transit trips between the origin and the destination across one or more modes of transportation, such as ferries, buses, rails, walking, etc. Given the multiple modes of transportation available between the origin and destination, these search algorithms can return a very large set of possible transit trips between the origin and destination. In addition, using multiple criteria (e.g. fare and time) to identify transit trips can result in many optimal results for the multiple criteria. Indeed, returning transit trips based on more than two criteria can easily result in thousands of possible transit trips.

Not all transit trips in the set of possible transit trips found using search algorithms are suitable for recommending to a user. A naïve way of selecting a subset of transit trips is to identify a subset of transit trips that optimize a specified criteria, such as shortest duration, earliest arrive time, cheapest fare, least amount of walking, etc. The problem with this approach is that some results determined in this manner would not make sense for recommendation to a user. As an example, most people would not pay ten times more for a trip to reduce five minutes of walking.

Other approaches for comparing and selecting a reasonable subset of transit trips from a large initial set of transit trips involve scoring the transit trips using complex algorithms to assess multiple criteria. These approaches require assumptions about several properties of the initial set of transit trips, such as Pareto-optimality. In addition, these approaches can require very complex algorithms that can be difficult and costly in terms of computing time and resources to implement.

### SUMMARY

Aspects and advantages of the invention will be set forth in part in the following description, or may be obvious from the description, or may be learned through practice of the invention.

One exemplary aspect of the present disclosure is directed to a computer-implemented method of identifying a subset of transit trips between an origin and a destination from a set of transit trips. The method includes obtaining transit trip data associated with the set of transit trips. The transit trip data includes information for determining the duration of one or more transit trips in the set. The method further includes generating a trip duration function for the set of transit trips based on the transit trip data. The trip duration function specifies a minimum trip duration over a time interval for the set of transit trips as a function of time. The trip duration function is a piecewise linear function comprising a plurality of linear trip segments. One or more of the linear trip segments models a trip duration, including waiting time, of one of the transit trips in the set of transit trips as a function of time. The method further includes filtering the set of transit trips to identify the subset of transit trips based on trip duration relative to the minimum trip duration specified by the trip duration function.

Other exemplary aspects of the present disclosure are directed to systems, apparatus, non-transitory computer-readable media, computer program products, user interfaces and devices for transit planning.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an overview of an exemplary system for transit trip planning according to an exemplary embodiment of the present disclosure;

FIG. 2 depicts a flow diagram of an exemplary method for selecting a subset of transit trips from a set of initial transit trips according to an exemplary embodiment of the present disclosure;

FIGS. 3 and 4 depict the exemplary generation of a trip duration function that specifies a minimum trip duration as a function of departure time according to an exemplary embodiment of the present disclosure;

FIG. 5 depicts an exemplary trip duration function that specifies a minimum trip duration as a function of arrival time according to an exemplary embodiment of the present disclosure;

FIG. 6 depicts an exemplary trip duration function for a set of transit trips that includes a frequency based transit trip according to an exemplary embodiment of the present disclosure;

FIG. 7 depicts the exemplary filtering of the set of transit trips based on the trip duration function according to an exemplary embodiment of the present disclosure; and

FIG. 8 depicts an exemplary computing system for transit route planning according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to systems and methods for filtering an initial set of transit trips between an origin and a destination to identify a subset of reasonable transit trips between the origin and the destination. Once identified, the subset of reasonable transit trips can be further analyzed based on various criteria (e.g. earliest arrival, lowest price, least amount of waking, least number of transfers, etc.) to recommend one or more transit trips to a user. The subset of reasonable transit trips can be identified by obtaining transit trip data suitable for identifying a trip duration (e.g. departure time, arrival time, and any associated penalties) for each trip in the initial set of transit trips. This transit trip data can be used to filter out trips from the set that do not provide an optimal or near optimal trip duration at some specific time over a time interval, such as over the course of a business day or other suitable time interval.

In particular, a trip duration function can be generated based on the trip data. The trip duration function can specify a minimum trip duration for the initial set of transit trips as a function of time, such as departure time or arrival time, over the time interval. For example, the trip duration function can be a function ƒ(t) that for each possible time “t” computes the trip duration associated with reaching the destination, including any possible waiting time. The function ƒ(t) can be based on departure time or arrival time. For instance, for departure times, the function ƒ(t) can specify for each possible departure time “t” the duration to reach the destination (i.e. a user departing at time “t” will arrive at the destination at time t+ƒ(t)). For arrival times, the function ƒ(t) can specify for each possible arrival time “t,” the duration before “t” the user should have left to reach the destination (i.e. a user desiring to arrive at time “t” should depart at time t−ƒ(t)).

The trip duration function can be a piecewise linear function with one or more linear trip segments. Each linear trip segment can model the duration, including waiting time, of one of the initial set of transit trips over at least a portion of the time interval. In particular implementations, one or more penalties can be added to the trip duration for each possible time “t” to take into account factors such as walking, transfers, pricing, preferred modes of transportation, etc. The penalties can be quantified as a unit of time. For instance, a transfer can be associated with a penalty of five minutes of travel.

The trip duration function can be used to filter trips from the initial set of transit trips to identify the subset of reasonable transit trips based on trip duration relative to the minimum trip duration specified by the trip duration function. In particular, each transit trip can be analyzed to determine whether the transit trip contributes to a minimum or optimal trip duration specified by the trip duration function. Transit trips that do not provide a trip duration within a threshold of the minimum trip duration specified by the trip duration function can be removed from the initial set of transit trips.

The trip duration function can be used to filter transit trips based on departure time or based on arrival time. For instance, a trip duration function specifying a minimum trip duration as a function of departure time can be used to identify a subset of reasonable trips responsive to departure time based requests. A trip duration function specifying a minimum trip duration as a function of arrival time can be used to identify a subset of reasonable trips responsive to arrival time based requests. Alternatively, filtering can be applied based on both departure time and arrival time. For instance, a first trip duration function can be used to filter trips based on departure time and a second trip duration function can be used to filter trips based on arrival time.

In this manner, a relatively large initial set of transit trips can be filtered to obtain a subset of reasonable transit trips. The filtering can take place using simple transit data associated with the transit trips, such as information suitable for identifying the duration of the transit trip and/or departure and arrival times for the transit trip. Filtering the transit trips in this manner can ensure that reasonable transit trips are selected for recommendation to a user when optimizing based on other factors, such as pricing, number of transfers, shortest duration, earliest arrival, departure time, required walking, and other factors.

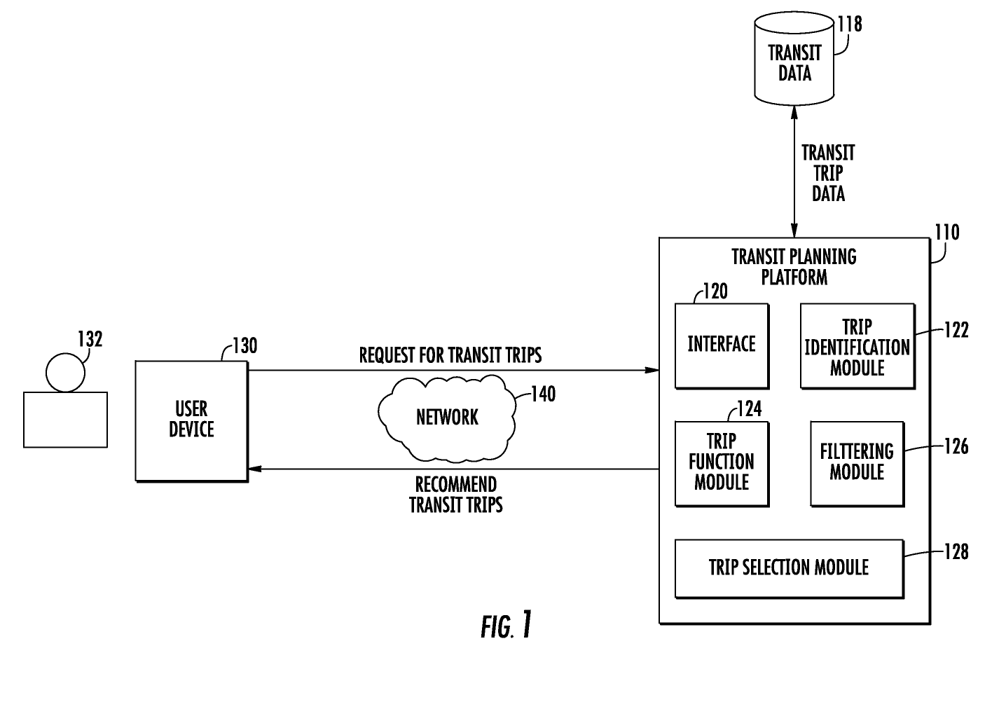

With reference now to the FIGS., exemplary embodiments of the present disclosure will now be discussed in detail. FIG. 1 depicts an overview of an exemplary system 100 for transit trip planning according to an exemplary embodiment of the present disclosure. The system 100 can include a transit planning platform 110 in communication with a computing device 130 over a network 140. The transit planning platform 110 can be hosted by any suitable computing device, such as a web server. The computing device 130 can be any suitable computing device, such as a laptop, desktop, smartphone, tablet, mobile device, wearable computing device, or other computing device.

A user 132 can input a request for one or more transit trips from an origin to a destination into the computing device 130 using a suitable user interface, such as a browser or other interface. The origin and destination are not necessarily transit stations. The origin and destination can be addresses, geographic coordinates, or other suitable designations of location. The computing device 130 can send the request for transit information to the transit planning platform 110. The request can be for a recommendation of specific transit trips between the origin and destination. The transit trips can be associated with one or more different transit routes and can use one or more modes of transportation, such as rails, ferries, buses, etc.

As used herein, a transit route is a fixed set of transit paths between an origin and a destination and can include multiple modes of transportation and multiple transit lines. An example transit route can be a combination of one or more bus lines, rail lines, walking paths, etc. that allow an individual to reach the destination. A transit trip is a specific instance of transportation over the transit route and is associated with a particular departure time and a particular arrival time. A transit route can include a plurality of transit trips over the transit route with different departure and arrival times.

The request can be a departure time based request or an arrival time based request. A departure time based request seeks transit trips between an origin and a destination that depart later than a specified time T. Usually, transit trips are optimized for arrival time in recommending transit trips responsive to the departure time based request. An arrival time based request seeks transit trips between an origin and a destination that arrive earlier than a specified time T. Transit trips are typically optimized for departure time in recommending transit trips responsive to the arrival time based request.

The transit planning platform 110 can receive the request from the computing device 130. For example, the transit planning platform 110 can include a suitable interface 120 for connecting to the network 140 and receiving the request. In response to the request, the transit planning platform 110 can access transit trip data 118. The transit trip data 118 can include information associated with the transit system, such as transit schedules, departure times, arrival times, stops, fares, walking distance, transfers, and other information associated with the transit system.

The transit planning platform 110 can implement a transit trip identification module 122 to obtain transit trip data associated with a set of transit trips between the origin and destination. The transit trip data includes information suitable for identifying the duration of one or more transit trips in the set of transit trips. Such information can include departure time, arrival time, and/or duration information for one or more transit trips in the set of transit trips. Obtaining the transit trip data can include accessing data associated with one or more transit trips between the origin and destination, for instance, from the transit trip data 118. The accessed data can be transit trip data associated with previously identified transit trips between the origin and destination. Alternatively, the transit trip identification module 122 can obtain the transit trip data by performing one or more transit route searching techniques to identify a plurality of transit trips associated with one or more transit routes between the origin and the destination.

The transit planning platform 110 can implement a trip function module 124 to generate one or more trip duration functions for the set of transit trips. A filtering module 126 can be implemented to filter the set of transit trips to identify a subset of reasonable transit trips between the origin and the destination. A trip selection module 128 can then be used to select one or more of the subset of transit trips to recommend to the user 132 in response to the request based on one or more factors, such as arrival time, departure time, duration, least walking, reduced prices, preferred routes, etc.

After the trip selection module 128 selects one or more transit trips for responding to the request, the transit planning platform 110 can send the transit trips to the user device 130, for instance, over the network 140. The user device 130 can then display the one or more time transit trips to the user 132 through a suitable user interface.

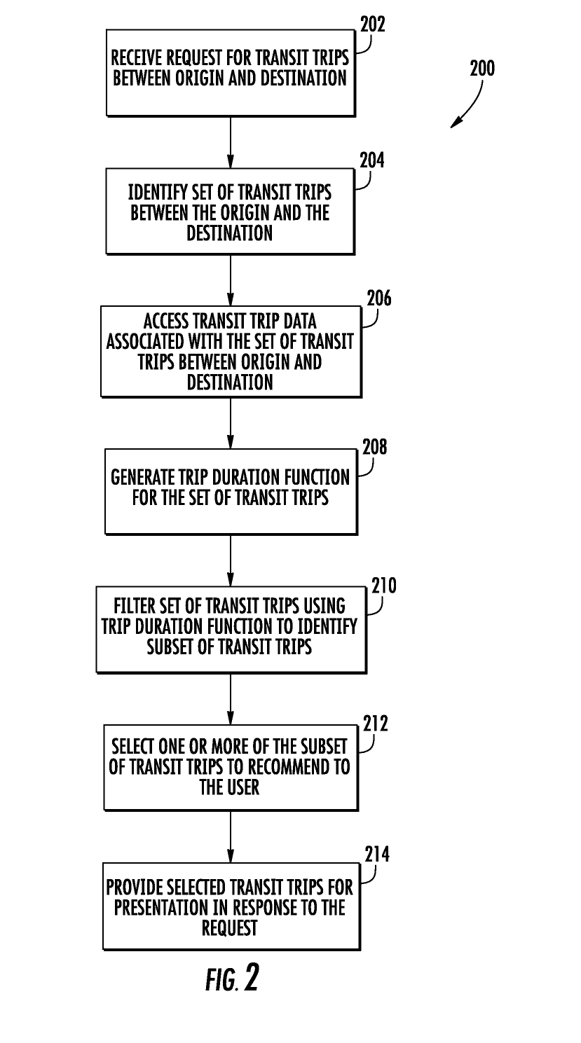

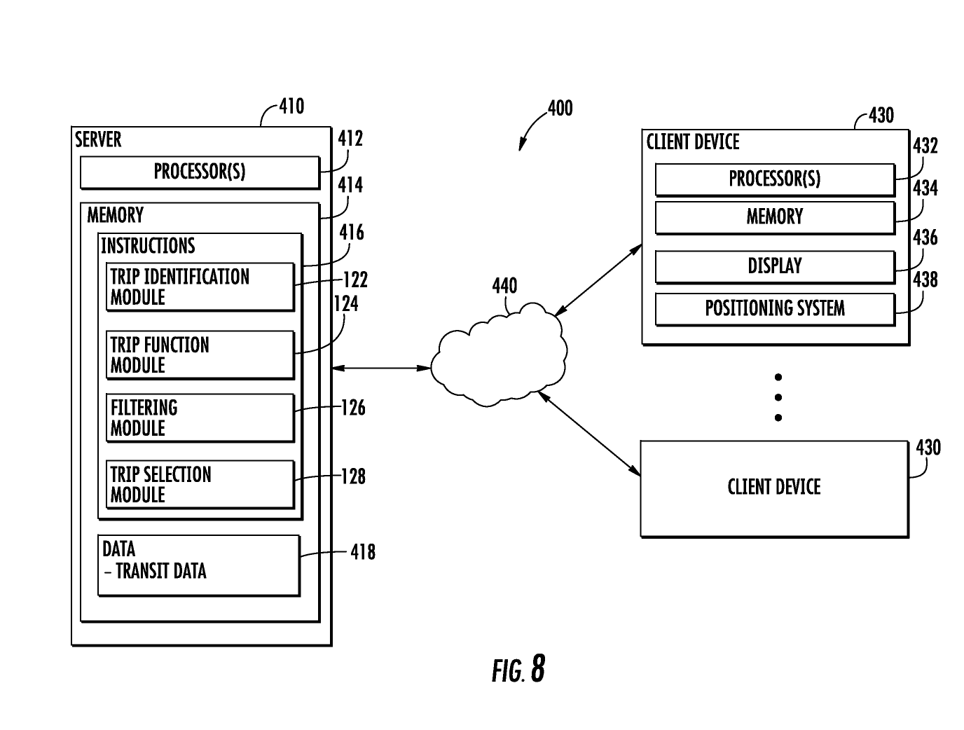

FIG. 2 depicts a flow diagram of an exemplary method (200) for identifying a subset of reasonable transit trips from an initial set of transit trips according to an exemplary embodiment of the present disclosure. The method (200) can be implemented using any suitable computing device or system, such as the system 400 depicted in FIG. 8. In addition, FIG. 2 depicts steps performed in a particular order for purposes of illustration and discussion. Those of ordinary skill in the art, using the disclosures provided herein, will understand that the various steps of any of the methods disclosed herein can be omitted, adapted, and/or rearranged in various ways.

At (202), the method includes receiving a request for transit trips between an origin and a destination. For instance, the transit planning platform 110 of FIG. 1 can receive a request for transit trips from a user device 130 over a network 140. The request can be a departure time based request or an arrival time based request. In addition, the request can ask for optimal transit trips based on one or more other factors, such as lowest fare, least amount of walking, shortest duration, least number of transfers, etc. The request can also be a request for typical transit routes from the origin to the destination irrespective of a specific time of day and/or date. Other suitable requests for transit information can be provided without deviating from the scope of the present disclosure.

At (204) of FIG. 2, the method includes identifying transit trips over a time interval between the origin and destination specified in the request. For instance, the trip identification module 122 of FIG. 1 can identify transit trips over a time interval between the origin and destination. The transit trips can be identified in any suitable manner. For instance, a transit graph representing the transit network between the origin and the destination can be searched using, for instance Djikstra search techniques, to identify a set of transit trips between the origin and destination. One exemplary search technique can include using an iterative search technique that penalizes transit arcs to identify as many possible transit routes as possible between the origin and destination. This transit route information can be annotated with particular transit trips based on transit trip data, such as a timetable of transit schedules.

The transit trips can occur over a time interval. The time interval can be any suitable time period, such as a business day, weekend, between the hours of 8:00 a.m. and 10:00 a.m., etc. In a particular implementation, the time interval can be based on a departure time or an arrival time set forth in the request. For instance, the time interval can include a range of times that begins at the earliest departure and/or arrival time and terminates at the latest departure and/or arrival time to meet time constraints specified in the request. The time interval can also be based on the identified transit trips. For instance, departure times and arrival times associated with the set of identified trips for each possible transit route can be used to define the time interval.

Many possible transit trips over the time interval can be identified between the origin and destination. Numerous of these transit trips will not be suitable or reasonable for recommending to a user. It is desirable to filter the initial set of transit trips to identify a subset of reasonable transit trips that can be analyzed for recommending to a user.

To identify a subset of reasonable transit trips, transit trip data associated with each of the transit trips in the set of transit trips is accessed (206). For instance, transit trip data can be accessed from the transit data 118 of FIG. 1. The transit trip data can include information necessary to identify the duration of one or more of the transit trips in the set of transit trips. For instance, the transit trip data can include the departure time, arrival time, and/or the duration of the transit trips. The departure time and the arrival time can be estimated time(s) or can be times determined or identified from data associated with the transit network, such as transit time tables. In certain embodiments, the duration of the transit trip can be determined from the arrival time and the departure time, for instance, by computing the difference between the arrival time and the departure time.

At (208), a trip duration function is generated for the initial set of transit trips. For example, the trip function module 124 of FIG. 1 can generate a trip duration function for the set of transit trips. The trip duration function specifies a minimum trip duration for the set of transit trips as a function of time (e.g. departure time or arrival time) for the time interval. For instance, the trip duration function can be a function ƒ(t) that specifies a minimum trip duration to reach the destination for every time t. The trip duration can incorporate penalties into the minimum duration for factors such as walking, required transfers, fares, etc. As will be discussed in more detail below, the trip duration function can be a piecewise linear function that includes a plurality of linear trip segments.

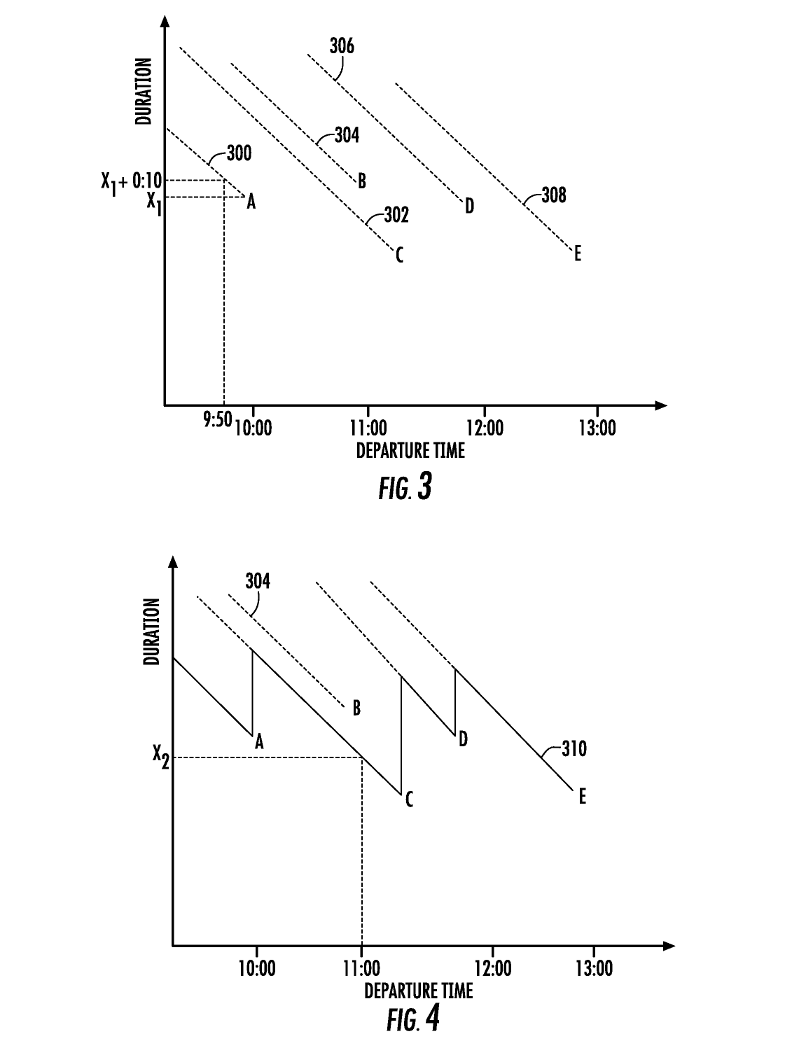

FIGS. 3 and 4 depict the exemplary generation of a trip duration function that specifies a minimum trip duration based on departure time for a set of transit trips according to an exemplary embodiment of the present disclosure. In particular, the trip duration function can be constructed by generating a linear trip segment for each transit trip in the set of transit trips. For instance, linear trip segments 300, 302, 304, 306, and 308 can be generated for transit trips A, B, C, D, and E respectively. The present example will be discussed with reference to five transit trips for purposes of illustration and discussion. Those of ordinary skill in the art, using the disclosures provided herein, will understand that the trip duration function can include any number of transit trips.

Each linear trip segment models a trip duration, including waiting time, of one of the transit trips in the set of transit trips as a function of time. The linear trip segment can be determined for a transit trip by identifying the duration and a departure time for the trip. The duration can simply be the trip duration and/or can also include penalties for factors such as walking, required transfers, pricing, etc. The linear trip segment specifies the duration of the trip at the departure time for the trip and has a slope of −1 to model waiting time. For example, trip A begins at 10:00 and has a duration of x1. The trip segment 300 associated with trip A has a slope of −1 to model waiting time. For instance, if a user begins travel at time 9:50, the user will have to wait 10 minutes until the transit trip A associated with trip segment 300 departs. Thus, the trip segment 300 specifies a trip duration of x₁+0:10 at time 9:50. The trip segments 302, 304, 306, and 308 can be modeled in a similar fashion.

As shown in FIG. 4, a trip duration function 310 is generated from the linear trip segments by identifying the minimum trip duration of each of the trip segments at each possible departure time. In particular, the trip duration function 410 specifies the minimum trip duration to reach the destination for each departure time. The minimum duration to arrive at the origin using the set of transit trips at a particular departure time can be determined by evaluating the trip duration function 310 at the particular departure time. For instance, the trip duration function 310 specifies a minimum trip duration of x2 for a departure time of 11:00 to arrive the destination using the set of transit trips A, B, C, D, and E.

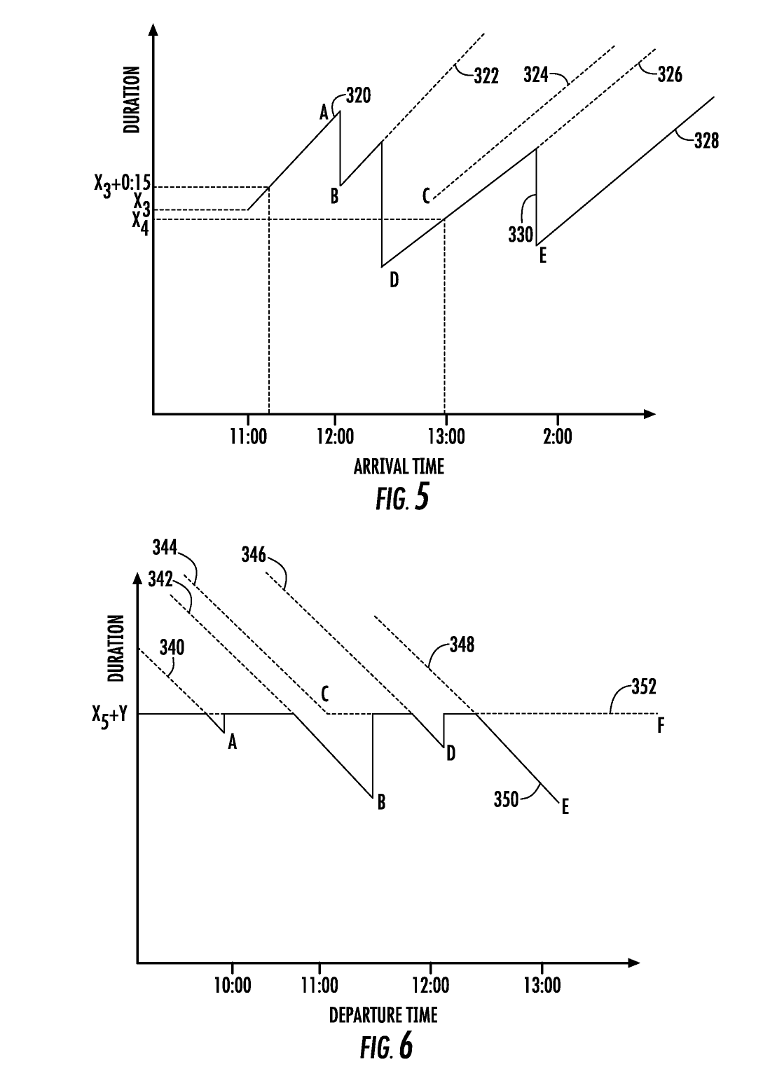

A trip duration function can also be generated based on arrival time. In particular, the trip duration function can specify a minimum trip duration as a function of each possible arrival time with in a time interval. FIG. 5 depicts an exemplary trip duration function 330 that specifies a minimum trip duration based on arrival time for a set of transit trips according to an exemplary embodiment of the present disclosure. The trip duration function 330 can be constructed by generating a linear trip segment for each transit trip in the set of transit trips. For instance, linear trip segments 320, 322, 324, 326, and 328 can be generated for transit trips A, B, C, D, and E respectively.

Each linear trip segment models a trip duration, including waiting time, of one of the transit trips in the set of transit trips as a function of arrival time. The linear trip segment can be determined for a transit trip by identifying the duration and an arrival time for the trip. The duration can simply be the trip duration and/or can also include penalties for factors such as walking, required transfers, fares, etc. The linear trip segment specifies the duration of the trip at the arrival time for the trip and has a slope of 1 to model waiting time. For example, trip A arrives at 11:00 and has a duration of x3. The trip segment 320 associated with trip A has a slope of 1 to model waiting time. For instance, if a user desires to arrive at 11:15, the user will have to wait 15 minutes after transit trip A arrives to arrive at the desired time. Thus, the trip segment 320 specifies a trip duration of x₃+0:15 at time 11:15. The trip segments 322, 324, 326, and 328 can be modeled in a similar fashion.

As shown in FIG. 5, a trip duration function 330 is generated from the linear trip segments by identifying the minimum trip duration of each of the trip segments at each possible arrival time. In particular, the trip duration function 330 specifies the minimum trip duration to reach the destination for each arrival time. The minimum duration to arrive at the origin using the set of transit trips at a particular departure time can be determined by evaluating the trip duration function 330 at the particular departure time. For instance, the trip duration function 330 specifies a minimum trip duration of x4 for an arrival time of 13:00 using the set of transit trips A, B, C, D, and E.

In some cases, the set of transit trips can include a frequency based transit trip. The exact departure and arrival times for the frequency based transit trip may be unknown. However, it may be known that over a given time interval, a particular transit trip runs every Y minutes and has a duration of x5. Based on this information, it is known that the frequency based trip will have a maximum duration of x5+Y including waiting time. A linear trip segment can be generated to model the frequency based trip as a linear segment having a slope of zero that specifies a duration equal to x5+Y.

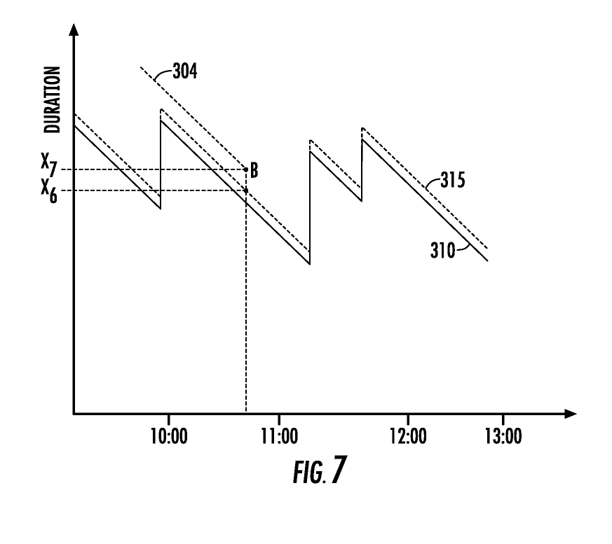

For example, FIG. 6 depicts a trip duration function 350 for a set of transit trips that includes a frequency based trip. The trip duration function 350 specifies a minimum trip duration as a function of departure time. The trip duration function 350 can be constructed by generating linear trip segments 340, 342, 344, 346, and 348 having a slope of −1 to model the duration, including waiting time, of trips A, B, C, D, and E respectively. The set can include an additional frequency based trip F. The frequency based transit trip F can have a duration of x5 and can run every Y minutes. A linear trip segment 352 having a slope of 0 and a value equal to x5+Y can be used to model the frequency based transit trip F. The trip duration function 350 can be constructed by identifying the minimum trip duration specified by the linear trip segments 340, 342, 344, 346, 348 and 352.

Referring back to FIG. 2 at (210), the method includes filtering the set of transit trips using the trip duration function to identify the subset of transit trips. For instance, the filtering module 126 can filter the set of transit trips using the trip duration function. More particularly, the set of transit trips is filtered based on trip duration relative to the minimum trip duration specified by the trip duration function. For instance, if a particular transit trip in the set of transit trips does not provide a trip duration within a threshold of the minimum trip duration specified by the trip duration function at any time within the time interval, the particular transit trip can be removed from the set.

As an example and referring to FIG. 4, transit trip B does not contribute to the trip duration function 310. More specifically, the linear trip segment 304 does not provide a trip duration that contributes to the minimum trip duration specified by the trip duration function. As a result, transit trip B can be removed from the initial set of transit trips to identify a subset of reasonable transit trips.

FIG. 7 depicts one exemplary process for filtering the set of transit trips based on a trip duration function 310 for the set of transit trips depicted in FIG. 4. A threshold function 315 can be generated based on the trip duration function 310. The threshold function 315 can be equal to the trip duration function plus some threshold Z. For instance, the threshold function can be specified as follows:

g(t)=ƒ(t)+Z

where g(t) is the threshold function, ƒ(t) is the trip duration function, and Z is the threshold. The threshold Z can be set to any desired value such as 10 minutes. In some cases the threshold Z can be set to zero such that the threshold function is equal to the trip duration function. The threshold Z can also be a function off(t). For instance, Z could be 10% or other suitable percentage off(t). In this example, g(t)=ƒ(t)+0.1*ƒ(t). This would allow for filtering of all trips that are worse than 10% off(t).

Once the threshold function is generated, the threshold function can be used to filter one or more transit trips in the set of transit trips. For instance, the threshold function can be evaluated at a time (e.g. a departure time or arrival time) associated with one of the transit trips to determine a threshold trip duration. For instance, in FIG. 7, the threshold function 315 can be evaluated at the departure time 11:00 associated with the transit trip B to obtain a threshold trip duration of x6. A trip duration associated with the transit trip at the same time can then be obtained. For instance, the linear trip segment 304 associated with transit trip B can be evaluated at the departure time 11:00 to obtain a trip duration of x7. The transit trip can be removed from the set of transit trips if the trip duration at the departure time of the trip exceeds the threshold trip duration. In the example of FIG. 7, the trip duration x7 associated with trip B exceeds the threshold trip duration x6. As a result, transit trip B is removed from the set of transit trips.

The filtering techniques can be applied using a trip duration function generated based on departure time or a trip duration function generated based on arrival time. In one particular implementation, the filtering techniques can be applied using both arrival time and departure time. For instance, a first trip duration function can be generated for a set of transit trips specifying a minimum trip duration for the set of transit trips as a function of departure time. A second trip duration function can be generated for the set of transit trips specifying a minimum trip duration for the set of transit trips as a function of arrival time. The set of transit trips can be filtered based on trip duration relative to the minimum trip duration specified by the first trip duration function and the minimum trip duration specified by the second trip duration function. Filtering based on both arrival time and departure time can provide useful results. For instance, the departure time filtering filters transit trips that arrive much later than optimal. The arrival time filtering filters transit trips that depart much earlier than optimal.

As an example, consider a request for transit trips specifying a departure time of 1 am. An ideal transit trip for recommending in response to the request would be to wait until the morning to take a direct tram (e.g. Tram 3) that arrives at 6:10 a.m. However, another transit trip identified in response to the request can include a transit trip that takes the latest tram (e.g. Tram 4) of the day and then requires waiting until 6am for the first tram (e.g. Tram 5) in the morning and taking the tram to arrive at 6:11 a.m. No reasonable user would opt for the latter transit trip. Filtering based only on departure time may not remove the latter transit trip from the set of transit trips because its arrival time is not much worse than optimal. However, the latter trip time would be filtered out using arrival time filtering. As a result, double filtering based on both departure time and arrival time can remove this kind of overnight trip.

Referring back to FIG. 2 at (212), once the subset of reasonable transit trips has been identified, the method can include selecting one or more of the subset of reasonable transit trips for recommendation to a user. For instance, the trip selection module 128 of FIG. 1 can select one or more of the subset of reasonable transit trips for recommendation to a user. The transit trips can be selected using any suitable criteria. For instance, the subset of reasonable transit trips can be analyzed based on several factors, such as duration, departure time, arrival time, fares, number of transfers, required walking, etc., to determine one or more optimal transit trips to recommend to the user.

At (212) of FIG. 2, the selected transit trips are provided for recommendation to the user in response to the request. For instance, the transit planning platform 110 of FIG. 1 can deliver the selected transit trips to the user device 130 over the network 140. The user 132 can then use the recommended transit trips in planning a transit journey.

FIG. 8 depicts an exemplary computing system 400 that can be used to implement the methods and systems for transit planning according to aspects of the present disclosure. The system 400 has a client-server architecture that includes a server 410 that communicates with one or more client devices 430 over a network 440. The system 400 can be implemented using other suitable architectures, such as a single computing device.

The system 400 includes a server 410, such as a web server. The server can host a transit planning platform. The server 410 can be implemented using any suitable computing device(s). The server 410 can have a processor(s) 412 and a memory 414. The server 410 can also include a network interface used to communicate with one or more remote computing devices (e.g. client devices) 430 over the network 440.

The processor(s) 412 can be any suitable processing device, such as a microprocessor, microcontroller, integrated circuit, or other suitable processing device. The memory 414 can include any suitable computer-readable medium or media, including, but not limited to, non-transitory computer-readable media, RAM, ROM, hard drives, flash drives, or other memory devices. The memory 414 can store information accessible by processor(s) 412, including instructions 416 that can be executed by processor(s) 412. The instructions 416 can be any set of instructions that when executed by the processor(s) 412, cause the processor(s) 412 to provide desired functionality. For instance, the instructions 416 can be executed by the processor(s) 412 to implement the trip identification module 122, the function 124, the filtering module 126, and the trip selection module 128.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, ROM, hard disk or optical or magnetic media.

Memory 414 can also include data 418, such as transit data, that can be retrieved, manipulated, created, or stored by processor(s) 412. The data 418 can be stored in one or more databases. The one or more databases can be connected to the server 410 by a high bandwidth LAN or WAN, or can also be connected to server 410 through network 440. The one or more databases can be split up so that they are located in multiple locales.

The server 410 can exchange data with one or more client devices 430 over the network 440. Although two clients 430 are illustrated in FIG. 8, any number of client devices 430 can be connected to the server 410 over the network 440. The client devices 430 can be any suitable type of computing device, such as a general purpose computer, special purpose computer, laptop, desktop, integrated circuit, mobile device, smartphone, tablet, wearable computing device, or other suitable computing device.

Similar the computing device 410, a client device 430 can include a processor(s) 432 and a memory 434. The memory 434 can store information accessible by processor(s) 432, including instructions that can be executed by processor(s) 432 and data. The client device 430 can include various input/output devices for providing and receiving information from a user, such as a touch screen, touch pad, data entry keys, speakers, and/or a microphone suitable for voice recognition. For instance, the computing device 430 can have a display 436 for presenting information, such as recommended transit trips to a user.

The client device 430 can also include a positioning system 438 that can be used to identify the position of the client device 430. The positioning system 438 can be optionally used by the user to monitor the user's position relative to a transit route. The positioning system 438 can be any device or circuitry for monitoring the position of the client device 430. For example, the positioning device 638 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position.

In situations in which the systems and method discussed herein collect information about users, such as position data, user preferences, or other information, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in or more ways before it is stored or used, so that personally identifiable information is removed.

The network 440 can be any type of communications network, such as a local area network (e.g. intranet), wide area network (e.g. Internet), or some combination thereof The network 440 can also include a direct connection between a client device 430 and the server 410. In general, communication between the server 410 and a client device 430 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of identifying a subset of transit trips between an origin and a destination from a set of transit trips, the method comprising:
obtaining transit trip data associated with the set of transit trips, the transit trip data comprising information for determining a duration for one or more transit trips in the set;
generating a trip duration function for the set of transit trips based on the transit trip data, the trip duration function specifying a minimum trip duration over a time interval for the set of transit trips as a function of time, the trip duration function being a piecewise linear function comprising a plurality of linear trip segments, one or more of the linear trip segments modeling a trip duration, including waiting time, of one of the transit trips in the set of transit trips as a function of time; and
filtering the set of transit trips to identify the subset of transit trips based on trip duration relative to the minimum trip duration specified by the trip duration function.

2. The computer-implemented method of claim 1, wherein the method comprises:
receiving a request for transit trips between the origin and the destination; and
recommending one or more transit trips from the subset of transit trips in response to the request.

3. The computer-implemented method of claim 1, wherein filtering the set of transit trips comprises removing one or more transit trips from the set that do not provide a trip duration within a threshold of the minimum trip duration specified by the trip duration function.

4. The computer-implemented method of claim 1, wherein the trip duration function specifies the minimum trip duration for the set of transit trips as a function of departure time over the time interval.

5. The computer-implemented method of claim 4, wherein one or more of the plurality of linear trip segments has a slope of −1 to model the trip duration, including waiting time, of one of the plurality of transit trips as a function of departure time.

6. The computer-implemented method of claim 1, wherein the trip duration function specifies the minimum trip duration for the set of transit trips as a function of arrival time over the time interval.

7. The computer-implemented method of claim 6, wherein one or more of the plurality of linear trip segments has a slope of 1 to model the trip duration, including waiting time, of one of the plurality of transit trips as a function of arrival time.

8. The computer-implemented method of claim 1, wherein generating the trip duration function for the set of transit trips based on the transit trip data comprises:
generating a first trip duration function specifying a minimum trip duration for the set of transit trips as a function of departure time; and
generating a second trip duration function specifying a minimum trip duration for the set of transit trips as a function of arrival time.

9. The computer-implemented method of claim 8, wherein filtering the set of transit trips comprises:
filtering the set of transit trips based on trip duration relative to the minimum trip duration specified by the first trip duration function; and
filtering the set of transit trips based on trip duration relative to the minimum trip duration specified by the second trip duration function.

10. The computer-implemented method of claim 1, wherein the set of transit trips comprises a frequency based transit trip.

11. The computer-implemented method of claim 10, wherein one of the plurality of linear trip segments of the trip duration function models the frequency based transit trip as a constant trip duration over at least a portion of the time interval.

12. The computer-implemented method of claim 1, wherein generating the trip duration function comprises:
generating a linear trip segment for each transit trip in the set of transit trips; and
identifying the minimum trip duration from the linear trip segments.

13. The computer-implemented method of claim 1, wherein filtering the set of transit trips based on trip duration relative to the minimum trip duration specified by the trip duration function comprises:
generating a threshold function specifying a threshold trip duration based on the trip duration function;
evaluating the threshold function to determine the threshold trip duration at a time associated with at least one of the transit trips in the set of transit trips;
obtaining a trip duration associated with the at least one transit trip; and
removing the at least one transit trip from the set of transit trips when the trip duration exceeds the threshold trip duration.

14. The computer-implemented method of claim 1, wherein generating a trip duration function for the set of transit trips comprises incorporating a penalty into the minimum trip duration specified by the trip duration function based at least in part on number of transfers, fares, required walking, preferred transit routes, or preferred modes of transportation.

15. A computing system for identifying a subset of transit trips between an origin and destination from a set of transit trips, the computing system comprising a processor and a memory, the system comprising:
a transit trip identification module implemented by the processor, the transit trip identification module configured to obtain transit trip data associated with the set of transit trips, the transit trip data comprising information for determining a duration for one or more transit trips in the set;
a trip function module implemented by the processor, the trip function module configured to generate a trip duration function for the set of transit trips based on the transit trip data, the trip duration function specifying a minimum trip duration over a time interval for the set of transit trips as a function of time, the trip duration function being a piecewise linear function comprising a plurality of linear trip segments, one or more of the linear trip segments modeling a trip duration, including waiting time, of one of the transit trips in the set of transit trips as a function of time; and
a filtering module implemented by the processor, the filtering module configured to filter the set of transit trips to identify the subset of transit trips based on trip duration relative to the minimum trip duration specified by the trip duration function.

16. The system of claim 15, wherein the trip function module is configured to generate the trip duration function for the set of transit trips by performing operations, the operations comprising:
generating a linear trip segment for each transit trip in the set of transit trips; and
identifying the minimum trip duration from the linear trip segments.

17. The system of claim 15, wherein the filtering module is configured to filter the set of transit trips by removing one or more transit trips form the set that do not provide a trip duration within a threshold of the minimum trip duration specified by the trip duration function.

18. The system of claim 17, wherein the filtering module is configured to filter the set of transit trips by performing operations, the operations comprising:
generating a threshold function specifying a threshold trip duration based on the trip duration function;
evaluating the threshold function to determine the threshold trip duration at a time associated with at least one of the transit trips in the set of transit trips;
obtaining a trip duration associated with the at least one transit trip; and
removing the at least one transit trip from the set of transit trips when the trip duration exceeds the threshold trip duration.

19. A computer-program product comprising a non-transitory tangible computer readable medium storing computer-readable instructions for identifying a subset of transit trips from a set of transit trips, the instructions when executed by a processor being configured to cause the processor to perform operations, the operations comprising:
obtaining transit trip data associated with the set of transit trips, the transit trip data comprising information for determining a duration for one or more transit trips in the set;
generating a first trip duration function for the set of transit trips based on the transit trip data, the first trip duration function specifying a minimum trip duration over a time interval for the set as a function of departure time, the first trip duration function being a piecewise linear function comprising a plurality of linear trip segments, one or more of the linear trip segments modeling a trip duration, including waiting time, of one of the transit trips in the set of transit trips as a function of departure time;
generating a second trip duration function for the set of transit trips based on the transit trip data, the second trip duration function specifying a minimum trip duration over a time interval for the set as a function of arrival time, the second trip duration function being a piecewise linear function comprising a plurality of linear trip segments, one or more of the linear trip segments modeling a trip duration, including waiting time, of one of the transit trips in the set of transit trips as a function of arrival time; and
filtering the set of transit trips to identify the subset of transit trips based on trip duration relative to the minimum trip duration specified by the first trip duration function and the minimum trip duration specified by the second trip duration function.

20. The computer-program product of claim 19, wherein the operation of filtering the set of transit trips comprises removing one or more transit trips from the set that do not provide a trip duration within a threshold of the minimum trip duration specified by the first trip duration function and the minimum trip duration specified by the second trip duration function.
